(19) United States
(12) Patent Application Publication
(10) Pub. No.: US 2013/0313487 A1
(43) Pub. Date: Nov. 28, 2013

(54) PLASTIC MOLDING COMPOSITION AND SINTERED PRODUCT

(71) Applicant: DENSO CORPORATION, Kariya-city (JP)

(72) Inventors: Yasuki Aoi, Gifu-city (JP); Mayumi Ozeki, Kariya-city (JP)

(73) Assignee: DENSO CORPORATION, Kariya-city (JP)

(21) Appl. No.: 13/898,698

(22) Filed: May 21, 2013

(30) Foreign Application Priority Data
May 22, 2012 (JP) 2012-116492

(51) Int. Cl. C04B 35/634; C04B 35/636

(52) U.S. Cl. CPC C04B 35/634; C04B 35/63488; C04B 35/6365
USPC 252/512; 106/156.1; 106/146.1; 106/156.5; 106/136.1

(57) ABSTRACT

A plastic molding composition includes a raw powder, gelatin, a polar solvent, and a plasticizer. The raw powder contains at least one of a ceramic particle and a metal particle. The plasticizer reduces the minimum amount of the solvent necessary to give flowability to the composition. The plasticizer is a water-soluble or water-dispersible compound. The plasticizer has a ratio of hydroxyl number to carbon number per molecule in a range from 8% to 100%. The plasticizer is in solid or liquid form. When the plasticizer is in liquid form, the plasticizer has volatility equal to or lower than volatility of water.

### CROSS REFERENCE TO RELATED APPLICATION

This application is based on Japanese Patent Application No. 2012-116492 filed on May 22, 2012, the disclosure of which is incorporated herein by reference.

### FIELD

The present disclosure relates to a composition for plastic molding and also relates to a sintered product manufactured by sintering a molded product which is molded from the composition.

### BACKGROUND

In a conventional method of manufacturing a sintered product, a molded product is formed by injection molding of a metal or ceramic powder and then sintered to form the sintered product. Generally, in injection molding of a metal or ceramic powder, a plastic molding composition is prepared by mixing the powder with a large amount of binder resin (binding agent) and used. In this case, in order to pour the composition in a molding die, the composition is heated to a temperature of, for example, 200° C. It is noted that when the binder resin is used, the sintered product is broken if the molded product is, sintered directly. Therefore, a degreasing process, in which the molded product is heated to a temperature of from 500° C. to 600° C. to decompose the binder, resin, needs to be performed before the molded product is sintered.

U.S. Pat. No. 4,734,237 corresponding to JP-B-2,604,592 discloses using a small amount of agar and water as a binder instead of binder resin. This approach can allow the composition to have flowability by heating the composition to a temperature of 80° C. to 100° C. Further, since the amount of the binder contained in the molded product is small, the degreasing process can become unnecessary.

### SUMMARY

The present inventors considered using gelatin instead of agar as a binder for injection molding of a metal or ceramic powder for reasons below.

When agar is used as a binder, a temperature of 80° C. or more is necessary to solate the agar so that the composition can have flowability. However, water, which is used as a solvent for the agar; vaporizes easily at this temperature. Therefore, water contained in the composition vaporizes during a process where the composition is prepared and during a process where the composition is injected in a molding die to form a molded product. Accordingly, the amount of water in the composition is likely to vary. Since the dimension of the sintered product can vary depending on the amount of water in the composition, a variation in the dimension of the sintered product can occur.

Generally, a solation temperature of gelatin is in a range from 10° C. to 50° C. When gelatin is heated to a temperature higher than the solation temperature, gelatin is solated. Therefore, compared to when agar is used, the composition can have flowability at a lower heating temperature by using gelatin and water as a binder. Accordingly, the variation in the amount of water in the composition can be reduced.

The present inventors actually tried to prepare a composition using gelatin and water as a binder. As a result, the present inventors found out that the addition of a large amount of water to the composition was required to allow the composition to have flowability for the following reason. The flowability of gelatin is provided when free water, which is able to freely move within a molecule at the time of solation, exists in the solvent. However, gelatin molecule takes up water as internal bonding water. Therefore, as the bonding water increases, the free water contributing to the flowability decreases. For this reason, it can be considered that extra water in gelatin molecule is necessary for the flowability.

The molded product is dried, before the molded product is sintered. If the composition contains a large amount of water, the molded product shrinks largely after being dried. Accordingly, some problems, such as a break in the molded product in the drying process and a variation in the dimension of the sintered product, can occur.

Therefore, it is preferable that the amount of water added to the composition to give flowability to the composition should be as small as possible. Although a polar solvent such as alcohol can be used as a solvent for gelatin instead of water, the above problems can occur even in such a case.

In view of the above, it is an object of the present disclosure to reduce the minimum amount of a solvent necessary to give flowability to a plastic molding composition which contains gelatin as a binder.

According to an aspect of the present disclosure, a plastic molding composition includes a powder, gelatin, a polar solvent, and a plasticizer. The powder contains at least one of a ceramic particle and a metal particle. The plasticizer reduces the minimum amount of the solvent necessary to give flowability to the composition. The plasticizer is a water-soluble or water-dispersible compound. The plasticizer has a ratio of hydroxyl number to carbon number per molecule in a range from 8% to 100%. The plasticizer is in either solid or liquid form. When the plasticizer is in liquid form, the plasticizer has volatility equal to or lower than volatility of water.

The addition of such a compound to the composition reduces the minimum amount of the solvent necessary to give the flowability to the composition compared to when such a compound is not added to the composition.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating evaluation results of flowability of compositions according to embodiments 1-11 of the present disclosure and comparison examples 1-6,

FIG. 2 is a diagram illustrating evaluation results of flowability of compositions according to embodiments 12-13 of the present disclosure and a comparison example 7,

FIG. 3 is a diagram illustrating evaluation results of flowability of compositions according to embodiments 14-15 of the present disclosure and a comparison example 8,

FIG. 4 is a diagram illustrating evaluation results of flowability of compositions according to embodiments 16-17 of the present disclosure and a comparison example 9,

FIG. 5 is a diagram illustrating evaluation results of flowability of compositions according to embodiments 18-19 of the present disclosure and a comparison example 10, and

FIG. 6 is a diagram illustrating evaluation results of flowability of compositions according to embodiments 20-21 of the present disclosure and a comparison example 11.

### DETAILED DESCRIPTION

A plastic molding composition according to the present disclosure is a mixture of a raw powder, gelatin, a polar solvent, and a plasticizer. The raw powder is a raw material of a sintered product and contains at least one of a ceramic particle and a metal particle.

Examples of the ceramic particle include an alumina particle or a zirconia particle. The raw powder can contain both a ceramic particle and a metal particle. Alternatively, the raw powder can contain only a ceramic particle without a metal particle. Alternatively, the raw powder can contain only a metal particle without a ceramic particle.

The raw powder can contain different types of ceramic particles. Likewise, the raw powder can contain different types of metal particles.

The gelatin is a binder (binding agent) and used by dissolving a gelatin powder into the polar solvent.

The gelatin, is manufactured by hydrolyzing collagen. For example, the collagen can be produced from a bone, a skin, a ligament, or a tendon of an animal. A solation temperature and a gelation temperature of the gelatin fall within a range from 10 to 50° C. The gelatin solates (i.e., changes to sol form) at a temperature not lower than the solation temperature and gelates (i.e., changes to gel form) at a temperature not higher than the gelation temperature. Examples of the gelatin include acid-treated beef bone gelatin, alkali-treated beef bone gelatin, and acid-treated pork skin gelatin. In some countries including Japan, a poorly-refined gelatin is called as the “glue”. The glue can be included in the gelatin defined in the specification.

The polar solvent is a solvent for dissolving the gelatin. Examples of the polar solvent include water and alcohol. If a solvent other than water is used, it is preferable that a solvent having volatility equal to or lower than that of water should be used.

The plasticizer is used to achieve plastic molding of the composition even when the amount of the solvent in the composition is reduced. That is, the plasticizer is used to reduce the amount of the solvent necessary to give the flowability to the composition.

A water-soluble or water-dispersible compound having a ratio of hydroxyl number to carbon number per molecule in a range from 8% to 100% can be used as the plasticizer.

The ratio of hydroxyl number to carbon number per molecule is calculated by the following formula. It is noted that each of m, n, and x in the general formula below is an arbitrary number.

In a compound expressed by CmHn..(OH)x, x/m×100(%)

The compound to be used as the plasticizer can be in either solid or liquid form. If the compound is in liquid form, the compound has volatility equal to or lower than that of water. When the volatility of the compound in liquid form is equal to or lower than that of water, a variation in the amount of the solvent in the composition before the composition is injected in the molding die can be reduced. Incidentally, since the vapor pressure of water at 20° C. is 2300 Pa, the compound in liquid form having the vapor pressure equal to or less than that of water at the same temperature can be used.

A reason for using a water-soluble or water-dispersible compound is that this compound is not separated from the polar solvent in the composition and the gelatin, which is hydrophilic. It is noted that a water-soluble or water-dispersible compound is not separated from the polar solvent, even if the polar solvent is different from water.

Examples of this type of compound include sugar alcohol, alcohol, sugar derivative, and polyalkylene glycol. In the case of polyalkylene glycol, low-molecular-weight polyalkylene glycol having a molecular weight of 600 or less is used (refer to embodiments 7, 10, and 11 and comparison examples 2 and 3, which are described later). One compound selected from these can be used. Alternatively, two or more compounds of the same or different types selected from these can be used.

The addition of such a compound to the composition containing the raw powder, the gelatin, and the polar solvent reduces the minimum amount of the solvent necessary to give the flowability to the composition compared to when such a compound is not added to the composition.

As shown in embodiments described later, this was experimentally discovered by the present inventors. A reason for this can be considered as follows. A compound containing a large number of hydroxyl groups has a high water absorption rate, i.e., has a strong bonding force with water molecule. Therefore, the addition of the compound containing a large number of hydroxyl groups to the composition can prevent the gelatin molecule from taking up the water molecule as internal bonding water. Even when the polar solvent is different from water, a compound containing a large number of hydroxyl groups has a strong bonding force with a molecule of the polar solvent. Therefore, the addition of the compound containing a large number of hydroxyl groups to the composition can prevent the gelatin molecule from taking up the molecule of the polar solvent.

A ratio of the gelatin and the polar solvent in the composition is determined based on a jelly strength of the gelatin, a target strength of a hardened molded product, and a viscosity of the composition. For example, the ratio can be 100 parts by weight of the raw powder, 3 to 20 parts by weight of the gelatin, and 6.5 to 22 parts by weight of water.

Regarding a ratio of the plasticizer in the composition, if the ratio of the plasticizer to the gelatin is too low, an effect of reducing the minimum amount of the solvent necessary to give the flowability to the composition cannot be obtained. Therefore, the ratio, of the plasticizer in the composition is determined so that this effect can be obtained. For example, as shown in the embodiments described later, the ratio of the plasticizer in the composition is determined so that the ratio of the gelatin to the plasticizer can be 100 parts by weight of the gelatin to 0.6 or more parts by weight of the plasticizer.

In contrast, if the ratio of the plasticizer to the raw powder is too high, the plasticizer is decomposed in the sintering process so that some voids can be produced. As a result, the specific gravity of the sintered product is reduced. Therefore, it is preferable that the ratio should be 10 or less parts by weight of the plasticizer to 100 parts by weight of the raw powder.

In addition to the plasticizer, another additive can be added to the composition. For example, a dispersant for dispersing the raw powder can be added.

Next, a method of manufacturing the sintered product from the composition according to the present disclosure is described.

Firstly, a composition, in which the raw powder, the gelatin, the polar solvent, and the plasticizer are mixed together at a predetermined ratio, is prepared. Then, the molded product is manufactured by injection molding of the prepared composition.

At this time, until the composition is injected in the molding die, the composition remains heated to a temperature higher than the solation temperature so that the composition can have the flowability. After the composition is injected in the molding die, the composition is cooled to a temperature lower than the gelation temperature. Thus, the composition is hardened so that the molded product can be manufactured.

Then, the molded product is dried and sintered so that the sintered product having a predetermined shape can be manufactured. It is noted that the gelatin is decomposed and removed in the sintering process.

In the above explanation, the molded product is manufactured by an injection molding method using the composition according to the present disclosure. The molded product can be manufactured not only by an injection molding method but also by other molding methods, which use a molding die, such as a transfer molding method, a compression molding method, or an extrusion molding method.

When the raw powder contains a ceramic particle, examples of the sintered product manufactured from the composition according to the present disclosure include an insulator of a spark plug of an internal-combustion engine, an O₂ sensor for detecting the concentration of oxygen in the exhaust gas, and an IC (integrated circuit) board. When the raw powder contains a metal powder, the sintered product can have electrical conductivity.

### EMBODIMENTS

### Embodiments 1-11, Comparison Examples 1-6

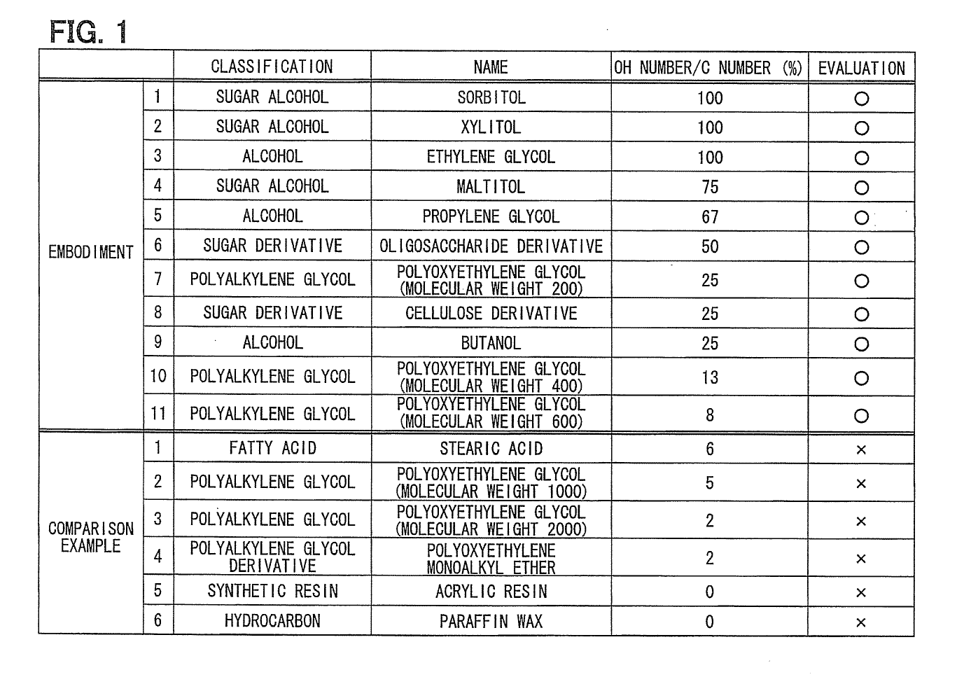

In the embodiments 1-11 and the comparison examples 1-6, a composition containing a compound shown in FIG. 1 was prepared, and it was evaluated whether the effect of reducing the minimum amount of the solvent necessary to give the flowability to the composition was obtained as compared to when such a compound was not added to the composition. It is noted that all of the compounds of the embodiments shown in FIG. 1 are water-soluble.

Specifically, the composition was prepared by mixing 100 parts by weight of low soda alumina with an average particle diameter of 2.5 μm, 8.5 parts by weight of acid-treated beef bone gelatin (jelly strength of 300 g) made by Nitta Gelatin Inc., 2 parts by weight of any of the compounds shown in FIG. 1, 0.5 parts by weight (active ingredient) of SN-Dispersant 5023 (dispersing agent) made by SAN NOPCO Ltd, and pure water in a testing machine which is designed for kneading-extrusion molding evaluation. It is noted that the pure water was added so that the amount of water in the composition can be 9 wt % of the composition.

An evaluation of the prepared composition was performed by using a flow tester in the following way. The viscosity and the share rate were measured under conditions that a test temperature was 50° C., a die size was φ0.5×1 mm, and a test load was 85 kgf, 165 kgf, and 260 kgf. A graph between the viscosity and the share rate was created from the three results, and the viscosity at the share rate of 150/s was calculated by an approximate method using the graph. When no compound was added to the composition, the viscosity of the composition exceeded 5000 Pa·s. Therefore, when the calculated viscosity exceeded 5000 Pa·s, the flowability was evaluated as “X”, and when the calculated viscosity was less than 5000 Pa·s, the flowability was evaluated as “O”.

As shown in FIG. 1, when any of the compounds of the comparison examples 1-6, each having the ratio of hydroxyl number to carbon number per molecule in a range from 0% to 6%, was added, a reduction in the viscosity of the composition, compared to when no compound was added, was not observed. In contrast, when any of the compounds of the embodiments 1-11, each having the ratio of hydroxyl number to carbon number per molecule in the range from 8% to 100%, was added, the reduction in the viscosity of the composition, compared to when no compound was added, was observed, and thus it was confirmed that the minimum amount of water necessary to give the flowability to the composition was reduced.

### Embodiments 12, 13 and Comparison Example 7

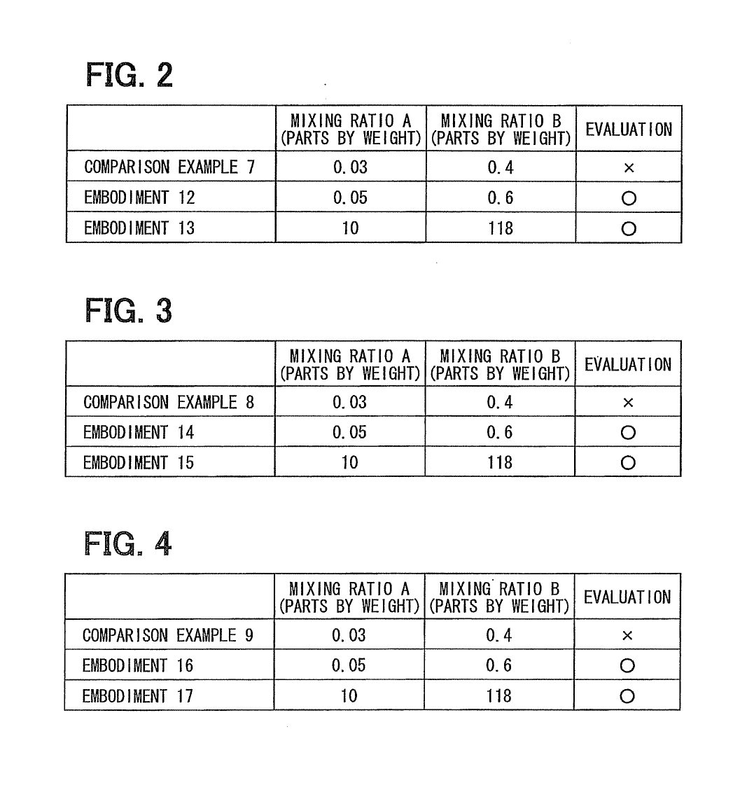

Like in the embodiment 1, sorbitol was used, and the flowability of a composition in which this compound was mixed at a ratio shown in FIG. 2 was evaluated in the same manner as the embodiment 1. In FIG. 2, a ratio A on the left side indicates a mixing ratio of the compound to 100 parts by weight of the raw powder, and a ratio B on the right side indicates a mixing ratio of the compound to 100 parts by weight of the gelatin (the same is true in FIGS. 3-6 below). A mixing ratio between the raw powder, the gelatin, and the water was the same as that in the embodiment 1.

Like in the embodiment 4, maltitol (Amalty MR-100 made by Mitsubishi Shoji Foodtech Co., Ltd.) was used, and the flowability of a composition in which this compound was mixed at a ratio shown in FIG. 3 was evaluated. A mixing ratio between the raw powder, the gelatin, and the water was the same as that in the embodiment 1.

### Embodiments 16, 17 and Comparison Example 9

Like in the embodiment 6, oligosaccharide derivative (P0-20 made by Mitsubishi Shoji Foodtech Co., Ltd.) was used, and the flowability of a composition in which this compound was mixed at a ratio shown in FIG. 4 was evaluated in the same manner as the embodiment 1. A mixing ratio between the raw powder, the gelatin, and the water was the same as that in the embodiment 1.

### Embodiments 18, 19 and Comparison Example 10

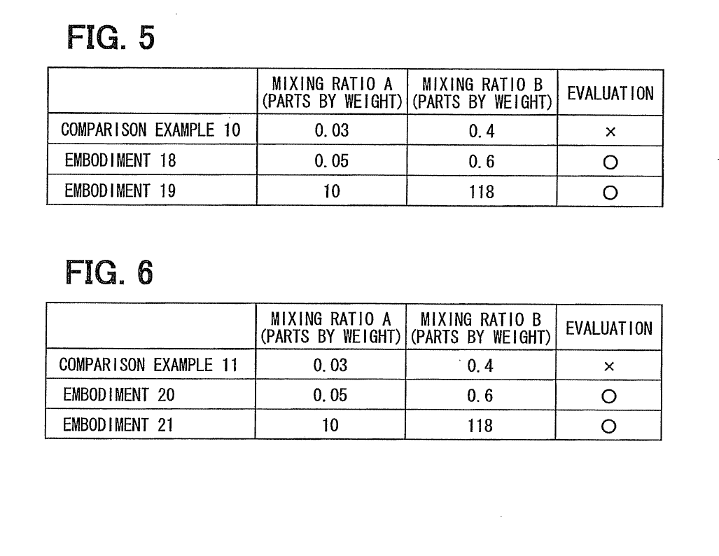

Like in the embodiment 7, polyoxyethylene glycol (molecular weight 200, PEG200 made by Sanyo Chemical Industries, Ltd.) was used, and the flowability of a composition in which this compound was mixed at a ratio shown in FIG. 5 was evaluated in the same manner as the embodiment 1. A mixing ratio between the raw powder, the gelatin, and the water was the same as that in the embodiment 1.

### Embodiments 20, 21 and Comparison Example 11

Like in the embodiment 10, polyoxyethylene glycol (molecular weight 400, PEG400 made by Sanyo Chemical Industries, Ltd.) was used, and the flowability of a composition in which this compound was mixed at a ratio shown in FIG. 6 was evaluated in the same manner as the embodiment 1. A mixing ratio between the raw powder, the gelatin, and the water is the same as that in the embodiment 1.

As shown in FIGS. 2-6, in each case where any compound was added, when the mixing ratio is 0.6 or more parts by weight of the compound to 100 parts by weight of the gelatin (refer to the mixing ratio B), and the mixing ratio is 10 or less parts by weight of the compound to 100 parts by weight of the raw powder (refer to the mixing ratio A), the reduction in the viscosity of the composition was observed, and thus it was confirmed that the minimum amount of water necessary to give the flowability to the composition was reduced.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A plastic molding composition comprising:
a powder containing at least one of a ceramic particle and a metal particle;
gelatin;
a polar solvent; and
a plasticizer that reduces the minimum amount of the solvent necessary to give a flowability to the composition, wherein
the plasticizer is a water-soluble or water-dispersible compound,
the plasticizer has a ratio of hydroxyl number to carbon number per molecule in a range from 8% to 100%,
the plasticizer is in solid or liquid form, and
when the plasticizer is in liquid form, the plasticizer has volatility equal to or lower than volatility of water.

2. The plastic molding composition according to claim 1, wherein
the compound is at least one selected from the group consisting of sugar alcohol, alcohol, sugar derivative, and low-molecular-weight polyalkylene glycol having a molecular weight of 600 or less.

3. The plastic molding composition according to claim 1, wherein
a mixing ratio of the compound to the gelatin is 0.6 or more parts by weight of the compound to 100 parts by weight of the gelatin, and
a mixing ratio of the compound to the powder is 10 or less parts by weight of the compound to 100 parts by weight of the powder.

4. A sintered product manufactured by molding and sintering the plastic molding composition according to claim 1.

5. The plastic molding composition according to claim 2, wherein
a mixing ratio of the compound to the gelatin is 0.6 or more parts by weight of the compound to 100 parts by weight of the gelatin, and
a mixing ratio of the compound to the powder is 10 or less parts by weight of the compound to 100 parts by weight of the powder.

6. A sintered product manufactured by molding and sintering the plastic molding composition according to claim 2.

7. A sintered product manufactured by molding and sintering the plastic molding composition according to claim 3.

8. A sintered product manufactured by molding and sintering the plastic molding composition according to claim 5.
